(19) United States
(12) Patent Application Publication
(10) Pub. No.: US 2022/0340322 A1
(43) Pub. Date: Oct. 27, 2022

(54) Systems and Methods for Reducing Friction for a Peel Plate

(71) Applicant: Avery Dennison Corporation, Glendale, CA (US)

(72) Inventors: Eric G. IDE, Wijk bij Duurstede (NL); Johannes DIEPENBACH, Leiderdorp (NL)

(21) Appl. No.: 17/620,875

(22) PCT Filed: Jul. 2, 2020
(86) PCT No.: PCT/US2020/040638

§ 371 Date: Dec. 20, 2021

Related U.S. Application Data
(60) Provisional application No. 62/870,151, filed on Jul. 3, 2019.

(51) Int. Cl. B65C 9/00; B65C 9/18

(52) U.S. Cl. CPC B65C 9/0006; B65C 9/1865; B65C 2009/0009

(57) ABSTRACT

A peel plate with a rotating rod is provided. The peel plate with the rotating rod may be used in a label dispensing system in place of a standard peel plate having a narrow-edged portion. The peel plate with the rotating rod reduces the friction over a liner (e.g., having labels disposed on both sides) during label dispensing of a first side, which would thereby reduce or eliminate the curling effect of the liner for subsequent (second side) label dispensing.

### CROSS REFERENCE TO RELATED APPLICATION

The present application claims the benefit of U.S. Provisional Patent Application No. 62/870,151 filed Jul. 3, 2019, which is incorporated herein in its entirety.

### BACKGROUND

Pressure sensitive labels (referred to herein as labels) are typically supported by a liner with a release system—typically a silicone system—(referred to herein as a liner) and wound into a roll on a core. FIG. 1 is an illustration 100 of an example roll 130 of liner 110 with labels 120. More particularly, the liner 110 has a first side and a second side, and labels 120 are disposed only on the first side of the liner 110. The label 120 is typically removed from the liner at the point of dispensing.

In current label dispensing systems (also referred to as dispensers, for example), a standard peel plate is provided for separating the labels 120 from the liner 110. FIG. 2 is an illustration of an example standard peel plate 200 having a narrow-edged portion 210.

FIG. 3 is an illustration 300 of an example liner 110 with a standard peel plate 200 of a simplified depiction of a dispensing system comprising an unwind roller 310 and a rewind roller 320. The roll 130 with the labels 120 disposed thereon is mounted on to the unwind roller 310. To dispense the labels 120 from the liner 110, one end of the liner 110 is coupled to the rewind roller 320, and the rewind roller 320 pulls the liner 110 from the unwind roller 310. As the liner 110 is pulled off of the unwind roller 310 and onto the rewind roller 320, a second side of the liner 110 (the side of the liner 110 that does not have the labels 120 disposed thereon) passes over a peel plate 200, the peel plate 200 having a narrow-edged portion 210, such as is shown in FIG. 2. Pulling the liner 110 over the peel plate 200 causes the labels 120 on the first side of the liner 110 to separate from the liner 110.

In such a conventional system, the second side of the liner is unused for labels to be disposed thereon, thereby increasing the amount of liner needed for label disposition and removal.

### SUMMARY

Systems for dispensing labels from a liner are described herein. In some embodiments, the system contains a peel plate containing at least one rod.

In some embodiments, the system includes an unwind roller for receiving a first end of the liner; a rewind roller for receiving a second end of the liner; and a peel plate over which the liner passes between the unwind roller and the rewind roller, wherein the peel plate is designed to reduce friction compared to a standard peel plate. In some embodiments, the peel plate includes a low friction or friction reducing peel plate for a label dispensing system over which a liner is moved is provided, the liner having labels disposed thereon.

In some embodiments, the systems include an unwind roller for receiving a first end of the liner; a rewind roller for receiving a second end of the liner; and a peel plate with at least one rotating rod over which the liner passes between the unwind roller and the rewind roller. In some embodiments, the peel plate contains a single rotating rod. In some embodiments, the peel plate includes a rotating rod over which a liner is moved, the liner having labels disposed thereon. In some embodiments, the peel plate exhibits reduced or low friction.

In still other embodiments, the system includes an unwind roller for receiving a first end of the liner; a rewind roller for receiving a second end of the liner; and a peel plate with at least one hollow, perforated rod. In some embodiments, the peel plate contains one hollow, perforated rod. The perforations can be any shape or size. The rod may rotate or be fixed. The rod can be connected to a compressed gas source, such as compressed air. Gas passing through the perforations creates an “air cushion” over which the liner moves; the liner does not contact the rod thereby reducing friction.

In still other embodiments, an unwind roller for receiving a first end of the liner; a rewind roller for receiving a second end of the liner; and a peel plate with at least two rods and a conveyor belt or strap. The belt or strap passes over the at least two rods. In some embodiments, the rods are rotating. The liner passes over the belt or strap, rather than contacting the rods, thereby reducing friction.

The configurations or designs described above with respect to the peel plate can be used alone or in combination.

Methods of dispensing labels using the systems described herein are also disclosed. In some embodiments, the method includes moving the liner over one or more of the peel plates described above. In other embodiments, the method includes moving the liner over a friction reducing peel plate.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is an illustration of an exemplary roll of liner with labels;

FIG. 2 is an illustration of an exemplary standard peel plate;

FIG. 3 is an illustration of an exemplary liner with a standard peel plate of a simplified dispensing system;

FIG. 4 is an illustration of an exemplary roll of liner with labels disposed on both sides of the liner;

FIG. 5 is an illustration of an exemplary roll of liner with labels disposed on both sides of the liner with a standard peel plate of a simplified dispensing system; and

FIG. 6 is an illustration of an exemplary friction reducing peel plate with a rotating rod.

FIG. 7 is an illustration of an exemplary friction reducing peel plate with a perforated rod.

FIG. 8 is an illustration of an exemplary friction reducing peel plate with two rotating rods and a conveyor belt or strap.

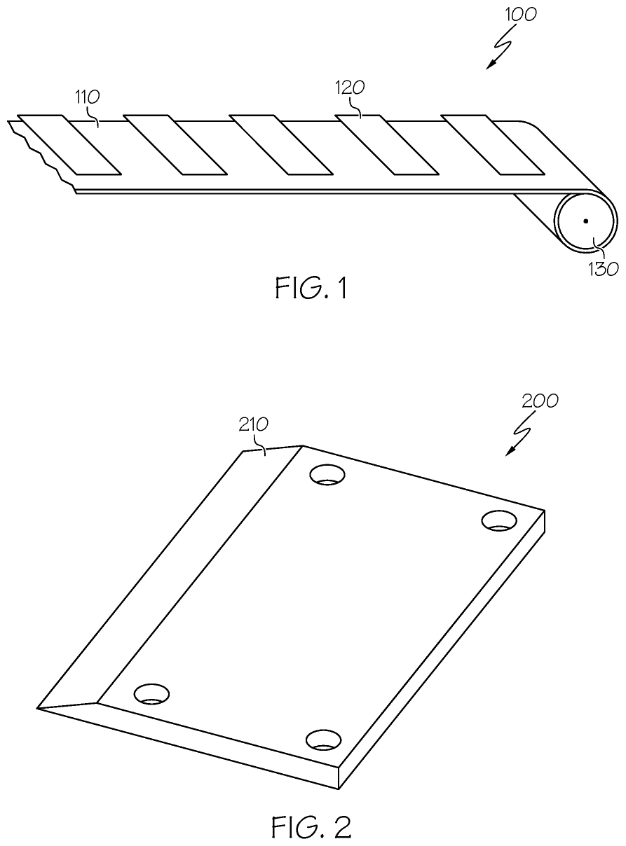

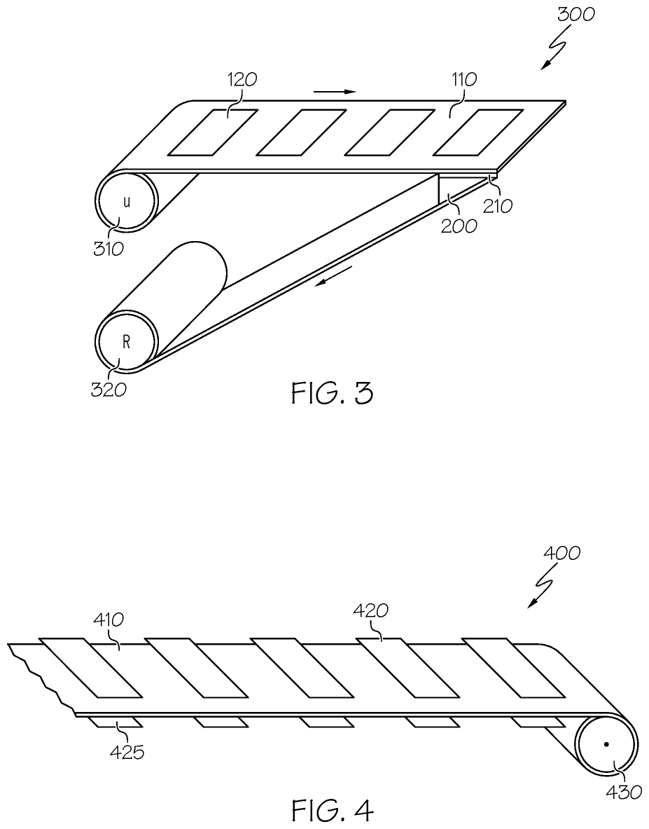

### DETAILED DESCRIPTION

Various implementations include systems and methods of dispensing labels from a two-sided laminated liner. These systems and methods make more efficient use of the liner because the liner can be used twice instead of once.

FIG. 4 is an illustration 400 of an example roll 430 of liner 410 with labels 420, 425 disposed on both sides of the liner 410, respectively. More particularly, the liner 410 has a first side and a second side, and labels 420 are disposed on the first side of the liner 410, and labels 425 are disposed on the second side of the liner 410. In some embodiments, the liner 410 is a two-side siliconized liner.

In some embodiments, a liner, such as the liner 410, having silicone disposed on the first and second sides thereof and a face material adhered to each side. Although silicone is described as being used, it is contemplated that other materials known in the art may be used. The face material is die cut into the shape of the labels 420, 425, and any sacrificial face material surrounding and/or in between the labels 420, 425 may or may not be removed from the liner 410. The liner 410, with the labels 420, 425 thereon, may be rolled on a core which in its turn is put on the unwind roller.

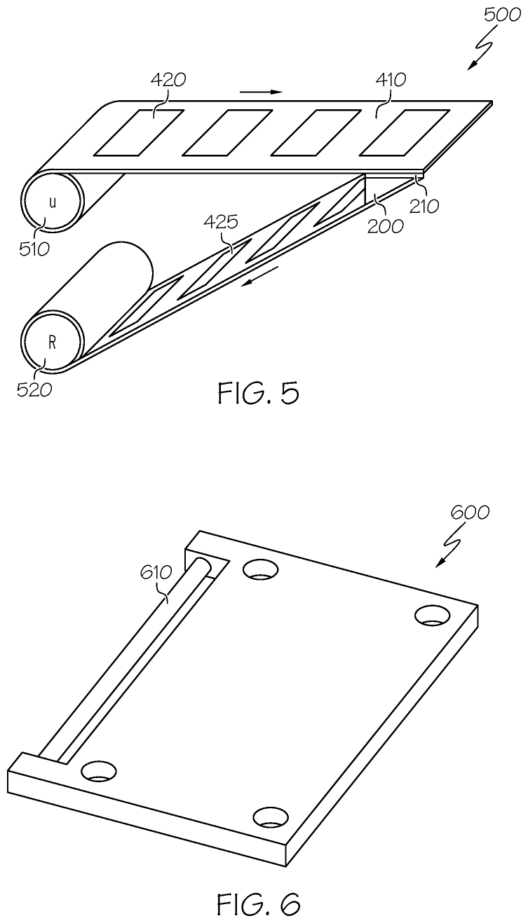

FIG. 5 is an illustration 500 of an example liner 410 with labels 420, 425 disposed on both sides of the liner 410, with a standard (conventional) peel plate 200 of a simplified dispensing system that contains an unwind roller 510 and a rewind roller 520. The liner 410 with the labels 420, 425 disposed thereon are put onto the unwind roller 410.

To dispense the labels 420 from the liner 410, one end of the liner 410 is coupled to the rewind roller 520, and the rewind roller 520 pulls the liner 410 from the unwind roller 510. As the liner 410 is pulled off of the unwind roller 510 and onto the rewind roller 520, a second side of the liner (the side of the liner 510 having the labels 425 disposed thereon) passes over the peel plate 200, the peel plate 200 having a narrow-edged portion 210. Pulling the liner 410 over the peel plate 200 causes the labels 420 on the first side of the liner 410 to separate from the liner 410.

However, it has been determined that side of the liner 410 having the labels 425 disposed thereon, which would be separated from the liner 410 in a subsequent (i.e., second) pass of the peel plate 200, incurs label curl and scuffing as a result of the liner 410 being moved/pulled over the peel plate 200 during the first pass in which the labels 420 are separated from the liner 410. In other words, pulling the liner 410 over the peel plate 200 in a first pass caused the liner 410 and labels 425 on the second side of the liner 410 to curl. In particular, because there are labels on two sides of the liner 410, the labels 425 that are dispensed during the second round of dispensing (i.e., the labels 425 on the second side of liner 410) run over the peel plate 200 during dispensing of the labels 420 on the first side of the liner 410. The labels 425 on the second side of the liner 410 curl after they have been pulled over the peel plate 200, much like the effect of curling a ribbon by pulling the ribbon over the blade of a pair of scissors at a sharp angle.

In order to reduce the friction over the liner 410 during label 420 dispensing, which would thereby reduce or eliminate the curling and scuffing effect of the liner 410 for subsequent (second side) label 425 dispensing, the standard peel plate 200 is replaced by a friction reducing peel plate.

Pulling the second side of the liner 410 over a reduced friction surface when the labels 420 on the first side are being dispensed reduces the curl of the liner 410 and the labels 425 on the second side of the liner 410. Moreover, in some implementations, pulling the liner over a reduced friction surface (such as a rotating rod) instead of the standard peel plate 200 prevents scuffing or dust (e.g., silicone dust) from being scraped from the second side of the liner 410 during the first round of label 420 dispensing.

FIG. 6 is an illustration of an exemplary reduced friction peel plate 600 with at least one rotating rod 610. The reduced friction peel plate 600 with the rotating rod 610 may be used in a dispensing system in place of the standard peel plate 200 with the narrow-edged portion 210. Thus, in some implementations, the peel plate 200 with a narrow-edged portion 210 is replaced with the reduced friction peel plate 600 comprising a passively rotating rod 610. Passing the liner 410 over the rotating rod 610 instead of the narrow-edged portion 210 of the peel plate 200 reduces curling of the liner 410 by reducing the friction between the liner 410 and the peel mechanism of the dispensing system. Although FIG. 6 shows a single rotating rod, the peel plate can contain multiple rotating rods, e.g., two, three, or more rods.

In some embodiments, the rotating rod 610 is cylindrically shaped and has a central axis about which the rod rotates. The rod may be solid, hollow, or both. In the implementation shown in FIG. 6, an axle extends through the rod 610 along the central axis of the rod 610. End portions of the axle adjacent each end of the axle are rotatably coupled to respective bosses coupled to the dispensing machine. For example, the bosses extend from a mounting plate, and the mounting plate is coupled to the dispensing machine using screws or any other suitable fastening mechanism. Bearings may be disposed between an external surface of each end portion of the axle and the inner surface of the opening defined by the bosses to reduce friction between the axle and the bosses. Any diameter size may be implemented for the rotating rod depending on the implementation.

Although a single axle is described above as extending through the rod 610, in other implementations, the rod 610 may be coupled to the bosses using a first axle and a second axle that are separate from each other. In such implementations, the first axle extends from one end of the rod 610, the second axle extends from a second end of the rod 610, and distal end portions of the axles are rotatably coupled to the bosses. The first and second axles extend along the rod's central axis, and bearings may be disposed between the external surface of each end portion of each axle and the inner surfaces of the openings defined by the bosses.

In other embodiments, end portions of the rotating rod 610 may be rotatably coupled to the bosses directly (i.e., without axles). In this alternative implementation, bearings may be disposed between the external surface of each end portion of the rod 610 and the inner surfaces of the openings defined by the bosses.

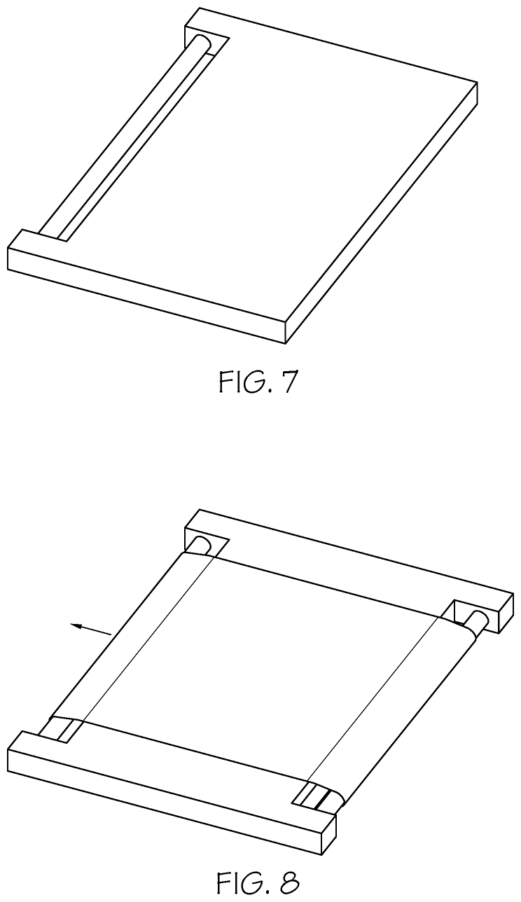

FIG. 7 shows another embodiment of a reduced friction peel plate in which the plate contains a hollow, perforated (or holes) rod which can be connected to a source of a gas, such as compressed air. The gas flows out of the perforations in the hollow rod to create an “air cushion” over which the liner will move. The “air cushion” prevents the liner from contacting the rod, thereby reducing friction. FIG. 7 shows a single hollow, perforated rod. However, the peel plate can contain multiple hollow, perforated rods, e.g., two, three, or more hollow, perforated rods.

FIG. 8 shows another embodiment of a reduced friction peel plate in which the plate contains two rods and a belt or strap, such as a conveyor belt or strap. The rods may be rotating rods. The belt or strap moves over the rods and the liner moves over the belt or strap to reduce friction. FIG. 8 shows two rods, such as rotating rods. However, the peel plate can contain more than two rods, such as three, four, or more rods. Again, the rods may be rotating rods.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A system for dispensing labels from a liner, comprising:
an unwind roller for receiving a first end of the liner;
a rewind roller for receiving a second end of the liner; and
a peel plate with at least one rod.

2. The system of claim 1, wherein the peel plate is a reduced friction peel plate.

3. The system of claim 1, wherein the peel plate is low friction.

4. The system of wherein the liner comprises a first set of labels on the first side of the liner, and a second set of labels on the second side of the liner.

5. The system of 1, wherein the rod comprises at least one rotating rod.

6. The system of claim 5, wherein the rotating rod is configured to separate a first set of labels from a first side of the liner as the liner is moved from the unwind roller to the rewind roller.

7. The system of claim 6, wherein the rotating rod is further configured to separate the second set of labels from the second side of the liner.

8. The system of claim 1, wherein the rod comprises at least one single, hollow, perforated rod.

9. The system of claim 8, wherein the rod is configured to separate a first set of labels from a first side of the liner as the liner is moved from the unwind roller to the rewind roller.

10. The system of claim 9, wherein the rod is further configured to separate the second set of labels from the second side of the liner.

11. The system of claim 1, wherein the rod comprises two rods and a conveyor belt or strap which passes over the two rods.

12. The system of claim 11, wherein the rods are configured to separate a first set of labels from a first side of the liner as the liner is moved from the unwind roller to the rewind roller.

13. The system of claim 12, wherein the rods are further configured to separate the second set of labels from the second side of the liner.

14. A system for dispensing labels from a liner, comprising:
an unwind roller for receiving a first end of the liner;
a rewind roller for receiving a second end of the liner; and
a peel plate over which the liner passes between the unwind roller and the rewind roller, wherein the peel plate is low friction or friction reducing.

15. The system of claim 14, wherein the liner comprises a first set of labels on the first side of the liner, and a second set of labels on the second side of the liner.

16. The system of claim 14, wherein the peel plate comprises a rotating rod.

17. The system of claim 16, wherein the rotating rod is configured to separate a first set of labels from a first side of the liner as the liner is moved from the unwind roller to the rewind roller.

18. The system of claim 17, wherein the rotating rod is further configured to separate the second set of labels from the second side of the liner.

19. The system of claim 14, wherein the rod comprises at least one single, hollow, perforated rod.

20. The system of claim 19, wherein the rod is configured to separate a first set of labels from a first side of the liner as the liner is moved from the unwind roller to the rewind roller.

21. The system of claim 20, wherein the rod is further configured to separate the second set of labels from the second side of the liner.

22. The system of claim 14, wherein the rod comprises two rods and a conveyor belt or strap which passes over the two rods.

23. The system of claim 22, wherein the rods are configured to separate a first set of labels from a first side of the liner as the liner is moved from the unwind roller to the rewind roller.

24. The system of claim 23, wherein the rods are further configured to separate the second set of labels from the second side of the liner.

25. A peel plate for a label dispensing system, the peel plate comprising at least one rod over which a liner is moved, the liner having labels disposed thereon.

26. The peel plate of claim 25, wherein the liner comprises the first set of labels on the first side of the liner, and a second set of labels on the second side of the liner.

27. The peel plate of claim 25, wherein the at least one rod comprises a rotating rod.

28. The peel plate of claim 25, wherein the at least one rod comprises a hollow, perforated rod.

29. The peel plate of claim 25, wherein the at least one rod comprises at least two rods and a conveyor belt or strap which passes over the at least two rods.

30. The peel plate of claim 25, wherein the at least one rod is friction reducing.

31. The peel plate of claim 25, wherein the at least one rod is low friction.

32. The peel plate of claim 25, wherein the at least one rod is configured to separate a first set of labels from a first side of the liner.

33. The peel plate of claim 32, wherein the rotating rod is further configured to separate the second set of labels from the second side of the liner.

34. A friction reducing peel plate for a label dispensing system over which a liner is moved, the liner having labels disposed thereon.

35. The peel plate of claim 34, wherein the liner comprises the first set of labels on the first side of the liner, and a second set of labels on the second side of the liner.

36. The peel plate of claim 34, wherein the friction reducing peel plate comprises a rotating rod.

37. The peel plate of claim 36, wherein the rotating rod is configured to separate a first set of labels from a first side of the liner.

38. The peel plate of claim 37, wherein the rotating rod is further configured to separate the second set of labels from the second side of the liner.

39. The peel plate of claim 34, wherein the friction reducing peel plate comprises at least one hollow, perforated rod.

40. The peel plate of claim 39, wherein the rod is configured to separate a first set of labels from a first side of the liner.

41. The peel plate of claim 40, wherein the rod is further configured to separate the second set of labels from the second side of the liner.

42. The peel plate of claim 34, wherein the friction reducing peel plate comprises at least two rods and a conveyor belt or strap which passes over the at least two rods.

43. The peel plate of claim 42, wherein the rod is configured to separate a first set of labels from a first side of the liner.

44. The peel plate of claim 43, wherein the rod is further configured to separate the second set of labels from the second side of the liner.

45. A method of dispensing labels from a liner, comprising moving the liner over the peel plate of claim 25.

46. The method of claim 45, further comprising separating a first set of labels from a first side of the liner as the liner is moved over the at least one rod.

47. The method of claim 46, further comprising separating the second set of labels from the second side of the liner using the at least one rod.
